(19) United States
(12) Patent Application Publication
(10) Pub. No.: US 2017/0076557 A1
(43) Pub. Date: Mar. 16, 2017

(54) MONEY DEPOSITING AND DISPENSING APPARATUS, MONEY DEPOSITING AND DISPENSING SYSTEM AND METHOD FOR TRAINING RELEASING METHOD OF ERROR CONDITION BY THE SAME

(71) Applicant: TOSHIBA TEC KABUSHIKI KAISHA, Tokyo (JP)

(72) Inventor: Yuji Yasui, Izunokuni (JP)

(21) Appl. No.: 15/180,181

(22) Filed: Jun. 13, 2016

(30) Foreign Application Priority Data
Sep. 15, 2015 (JP) 2015-182085

(51) Int. Cl. G07F 19/00; G07G 1/00; G07D 11/00

(52) U.S. Cl. CPC G07F 19/00; G07D 11/0039; G07F 19/203; G07F 19/202; G07G 1/0009

(57) ABSTRACT

In accordance with an embodiment, a money depositing and dispensing apparatus comprises a conveyance section, a reception module, a conveyance control module and a notification module. The conveyance section at least conveys either deposited money or dispensed money. The reception module receives a generation notification used to generate an error which relates to the conveyance section and is to be experienced by an operator. In a case in which the reception module receives the generation notification, the conveyance control module prohibits the conveyance of money by the conveyance section. The notification module notifies that the error, received by the reception module, which relates to the conveyance section, is generated.

### CROSS-REFERENCE TO RELATED APPLICATION

This application is based upon and claims the benefit of priority from Japanese Patent Application No. 2015-182085, filed Sep. 15, 2015, the entire contents of which are incorporated herein by reference.

### FIELD

Embodiments described herein generally relate to a money depositing and dispensing apparatus, a money depositing and dispensing system and a method for training a releasing method of an error condition by the same.

### BACKGROUND

Conventionally, in a store such as a supermarket, instead of a drawer storing cash, a money depositing and dispensing system with which a money depositing and dispensing apparatus is connected is used in a commodity sales data processing apparatus such as a POS (Point Of Sales) terminal. The money depositing and dispensing apparatus can automatically store money and dispense change.

Incidentally, when storing money received as payment or dispensing change, a problem such as money jam occurs in the money depositing and dispensing apparatus in some cases. If such an error condition occurs, an operator has to release the error condition immediately. Thus, a money depositing and dispensing apparatus has been disclosed, which can train methods for releasing an error condition when a problem such as money jam occurred. In a condition in which such a money depositing and dispensing apparatus is set to a mode in which the problem occurs, it generates the problem if the money depositing or money dispensing is operated. In this way, the operator can train the releasing method of error conditions.

However, to generate the error conditions, money is used in the conventional money depositing and dispensing apparatus. Consequently, there is a high possibility that amount of money in the conventional money depositing and dispensing apparatus becomes inaccurate since the jammed money is put into the money depositing and dispensing apparatus by mistake or miscalculation condition occurs due to the money jam. Thus, in a case of training the releasing method for the error conditions, a burdensome large-scale arrangement is required such as removing the money from the money depositing and dispensing apparatus or preparing the money for training.

### DESCRIPTION OF THE DRAWINGS

FIG. 1 is an external perspective view of a money depositing and dispensing system according to an embodiment;

FIG. 2 is a block diagram illustrating the hardware constitution of a POS terminal;

FIG. 3 is a block diagram illustrating the hardware constitution of a money depositing and dispensing apparatus;

FIG. 4 is an illustration diagram illustrating an example of a pseudo error table;

FIG. 5 is a block diagram illustrating functional components of all devices in the money depositing and dispensing system;

FIG. 6 is an illustration diagram illustrating an example of a pseudo error selection screen;

FIG. 7 is an illustration diagram illustrating an example of a confirmation screen;

FIG. 8 is an illustration diagram illustrating an example of an operation input screen;

FIG. 9 is an illustration diagram illustrating an example of a POS terminal notification screen;

FIG. 10 is an illustration diagram illustrating an example of a POS terminal guide screen;

FIG. 11 is an illustration diagram illustrating an example of a money depositing and dispensing apparatus notification screen;

FIG. 12 is an illustration diagram illustrating an example of a money depositing and dispensing apparatus guide screen;

FIG. 13 is a flowchart illustrating an example of a pseudo error processing executed by the depositing and dispensing system; and

FIG. 14 is an external perspective view illustrating the schematic constitution of a self-POS terminal serving as another embodiment.

### DETAILED DESCRIPTION

In accordance with an embodiment, a money depositing and dispensing apparatus comprises a conveyance section, a reception module, a conveyance control module and a notification module. The conveyance section at least conveys either deposited money or dispensed money. The reception module receives a generation notification used to generate an error which relates to the conveyance section and is to be experienced, detected, and/or observed by an operator. In a case in which the reception module receives the generation notification, the conveyance control module prohibits the conveyance of money by the conveyance section. The notification module notifies that the error, received by the reception module, which relates to the conveyance section is generated.

Hereinafter, embodiments of a money depositing and dispensing apparatus, a money depositing and dispensing system and a method for training a releasing method of an error condition by the same are described below in detail with reference to the accompanying drawings. Further, the embodiment described below is one embodiment of a money depositing and dispensing apparatus, a money depositing and dispensing system and a method for training the releasing method of the error condition by the same, and no limitations are given to the constitution and specification thereof. The present embodiment is an application example to a money depositing and dispensing system which is introduced to a store such as a supermarket to carry out a depositing and dispensing processing relating to depositing bills and/or coins or dispensing bills and/or coins as change.

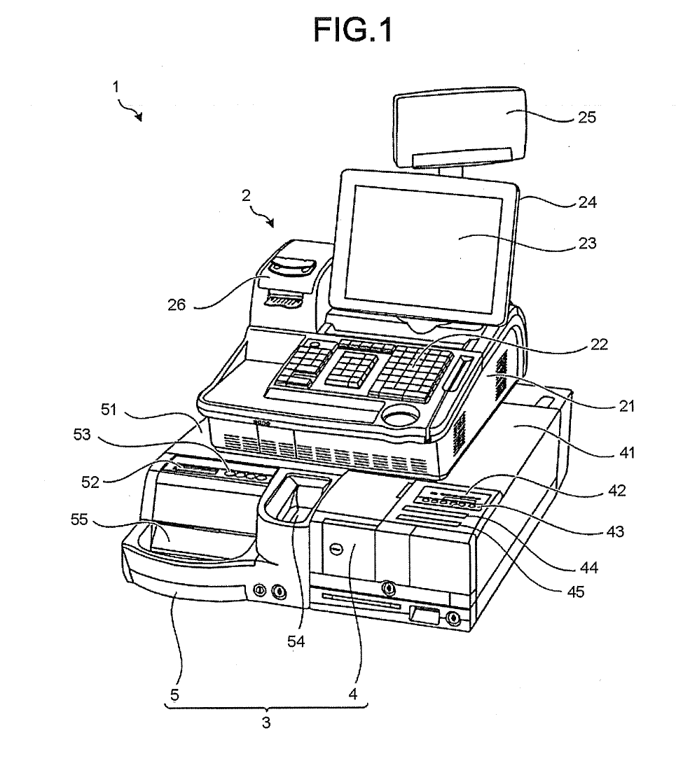

FIG. 1 is an external perspective view illustrating a money depositing and dispensing system 1 according to the embodiment. The money depositing and dispensing system 1 comprises a POS terminal 2 and a money depositing and dispensing apparatus 3. The operator is trained by experiencing error conditions of the money depositing and dispensing system 1 in a pseudo manner. The POS terminal 2 receives an input of selecting an error condition that the operator desires to experience. The POS terminal 2 and the money depositing and dispensing apparatus 3 become the pseudo error condition according to the selected item. Then, when detecting a predetermined operation, the POS terminal 2 and the money depositing and dispensing apparatus 3 are restored to a normal operational condition from the pseudo error condition. In this way, the operator can be trained to restore the money depositing and dispensing system 1 from the error condition.

Next, the detailed constitutions of various kinds of devices constituting the money depositing and dispensing system 1 are described.

The POS terminal 2 is a commodity sales data processing apparatus which registers sales data based on commodity information of commodities purchased by a customer. As shown in FIG. 1, the POS terminal 2 comprises a casing 21 in which a control section 200 (refer to FIG. 5) is housed. The POS terminal 2 is further equipped with a keyboard 22 above the casing 21. The POS terminal 2 also comprises a display section 24 for store clerk easy observation at the rear side of the keyboard 22 above the casing 21, and a touch panel 23 is arranged on the surface of the display section 24 for store clerk. For example, the display section 24 for store clerk is a display device such as a liquid crystal display. The display section 24 for store clerk displays various kinds of information relevant to the store clerk, for example. Further, the POS terminal 2 is equipped with a display section 25 for customer viewing which protrudes from the upper surface of the casing 21 above the display section 24. For example, the display section 25 for customer viewing is a display device such as a liquid crystal display. The display section 25 for customer displays various kinds of information relevant to the customer, for example.

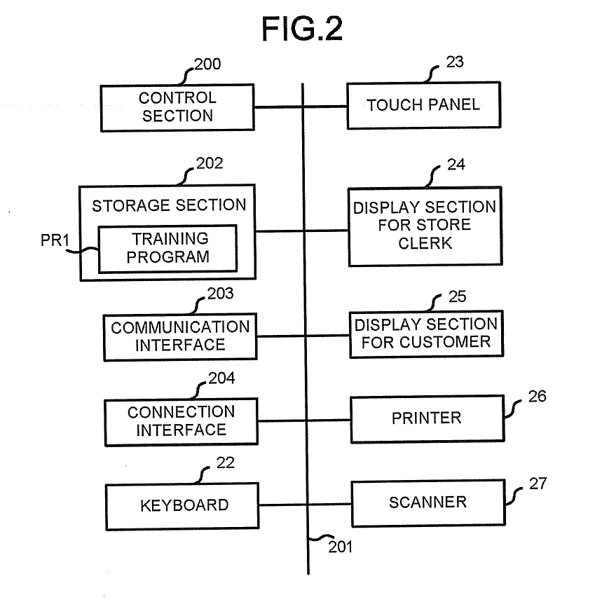

Further, the POS terminal 2 comprises a printer 26, which prints a receipt or a journal, at the left side of the display section 24. A scanner 27 (refer to FIG. 2), which can be a laser type hand scanner or an optical reading-type vertical scanner, is connected to the POS terminal 2 and used.

The POS terminal 2 reads commodity information in commodity identification information read by the scanner 27 (refer to FIG. 2) from a commodity master file (not shown). Then, the POS terminal 2 generates, based on sales amount and the number of sales contained in the read commodity information, sales data including subtotal amount and total amount, and registers the sales data in a sales file. If deposit amount is input through the keyboard 22, the POS terminal 2 calculates change by subtracting the deposit amount from the total sales amount. Then, the POS terminal 2 outputs a money dispensing instruction to the money depositing and dispensing apparatus 3 to dispense the calculated change. Then, the POS terminal 2 displays the total sales amount, the change and the like on the display section 24 for store clerk and the display section 25 for customer. Further, the deposit amount which is counted by the money depositing and dispensing apparatus 3 may be notified to the POS terminal 2, and the POS terminal 2 may calculate the change based on the deposit amount.

The money depositing and dispensing apparatus 3 stores deposit amount from the customer by each denomination, and notifies the POS terminal 2 of the deposit amount, and in this way, the deposit processing is executed. Moreover, when receiving a change dispensing instruction from the POS terminal 2, the money depositing and dispensing apparatus 3 determines the number of dispensed cashes of each denomination, then executes a money dispensing processing of dispensing bills and/or coins of each denomination.

As shown in FIG. 1, the money depositing and dispensing apparatus 3 comprises a bill depositing and dispensing unit 4 and a coin depositing and dispensing unit 5. Further, the money depositing and dispensing apparatus 3 may comprise either the bill depositing and dispensing unit 4 or the coin depositing and dispensing unit 5.

The bill depositing and dispensing unit 4 comprises a first display section 42, a first operation section 43, a bill depositing port 44 and a bill dispensing port 45 on the top surface of a casing 41. For example, the first display section 42 is a display device such as a liquid crystal display. The first operation section 43 has operation buttons for operating the bill depositing and dispensing unit 4. The bill depositing port 44 receives deposit of bills. The bill dispensing port 45 dispenses bills.

The coin depositing and dispensing unit 5 comprises a second display section 52 and a second operation section 53 on the top surface of a casing 51. For example, the second display section 52 is a display device such as a liquid crystal display. The second operation section 53 has operation buttons for operating the coin depositing and dispensing unit 5. The coin depositing and dispensing unit 5 also comprises a coin depositing port 54 at the right-near end part of the top surface of the casing 51, and a plurality of coins can be once input into the coin depositing port 54. The coin depositing and dispensing unit 5 also comprises a coin dispensing port 55 at the left-near end part of the casing 51, and the coins can be dispensed from the coin dispensing port 55.

Next, the hardware constitutions of various kinds of devices of the money depositing and dispensing system 1 are described.

First, the hardware constitution of the POS terminal 2 is described. FIG. 2 is a block diagram illustrating the hardware constitution of the POS terminal 2.

As shown in FIG. 2, the POS terminal 2 is provided with a control section 200 which controls various operations and all sections of the POS terminal 2 collectively. The control section 200 consists of a CPU (Central Processing Unit), a ROM (Read Only Memory), a RAM (Random Access Memory), a RTC (Real Time Clock) and the like. The ROM is a storage medium storing various kinds of programs and data. The RAM is a storage medium which stores various kinds of programs temporarily or rewrites various data. The RTC counts the current date and time.

The control section 200 connects with a storage section 202, a communication interface 203, a connection interface 204, the keyboard 22, the touch panel 23, the display section 24 for store clerk, the display section 25 for customer, the printer 26 and the scanner 27 via a bus line 201.

The storage section 202 is a storage device such as an HDD (Hard Disk Drive) or an SSD (Solid State Drive). The storage section 202 stores various setting information and programs for executing various POS jobs including the commodity sales data processing. Further, the storage section 202 stores a training program PR1. The training program PR1 is used to exert a characteristic function of the POS terminal 2.

The communication interface 203 connects with the in-store network. The connection interface 204 connects with the money depositing and dispensing apparatus 3.

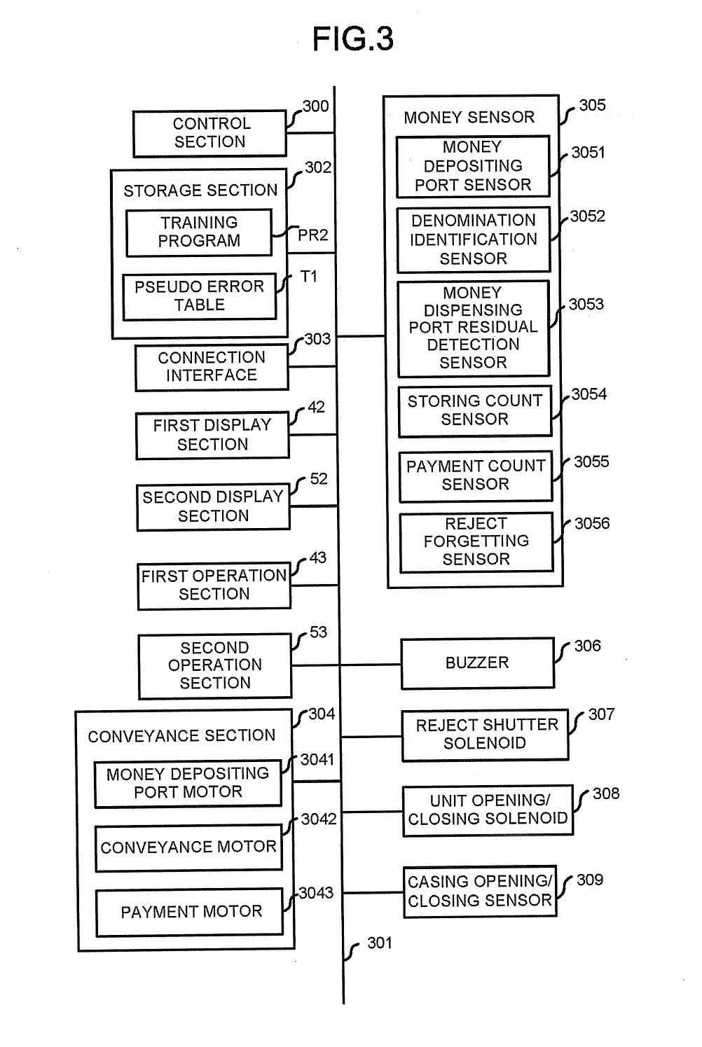

Next, the hardware constitution of the money depositing and dispensing apparatus 3 is described. FIG. 3 is a block diagram illustrating the hardware constitution of the money depositing and dispensing apparatus 3.

As shown in FIG. 3, the money depositing and dispensing apparatus 3 is provided with a control section 300 which collectively controls various processing such as the money depositing processing, the money dispensing processing and the like and all sections of the money depositing and dispensing apparatus 3. The control section 300 consists of a CPU, a ROM, a RAM, a RTC and the like. The ROM is a storage medium storing various kinds of programs and data. The RAM is a storage medium which stores various kinds of programs temporarily or rewrites various data. The RTC counts the current date and time.

The control section 300 connects with a storage section 302, a connection interface 303, the first display section 42, the second display section 52, the first operation section 43, the second operation section 53, a conveyance section 304, a money sensor 305, a buzzer 306, a reject shutter solenoid 307, a unit opening/closing solenoid 308 and a casing opening/closing sensor 309 via a bus line 301.

The storage section 302 is a storage device such as an HDD or an SSD. The storage section 302 stores various setting information and programs for executing various processing including the money depositing processing, the money dispensing processing and the like. Further, the storage section 302 stores a training program PR2 and a pseudo error table T1. The training program PR2 is used to carry out a characteristic function of the money depositing and dispensing apparatus 3.

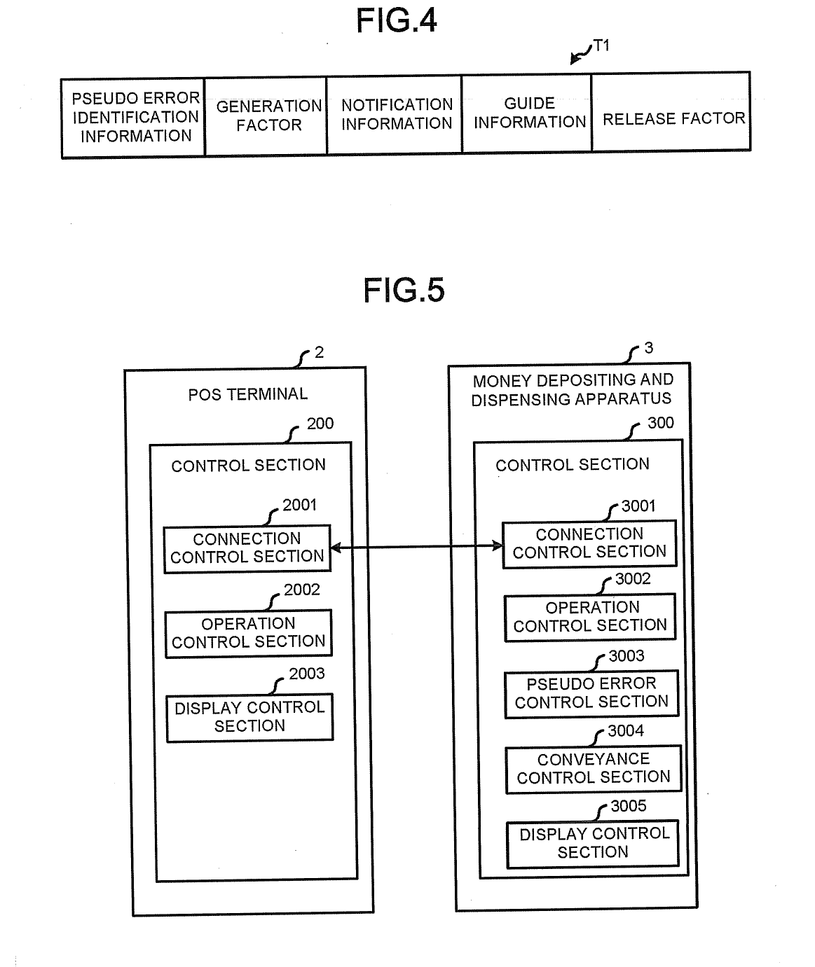

The storage section 302 stores the pseudo error table T1. The pseudo error table T1 stores information relating to pseudo errors. Herein, FIG. 4 is an illustration diagram illustrating an example of the pseudo error table T1. The pseudo error table T1 stores, for example, a generation factor, notification information, guide information and a release factor associated with each pseudo error identification information. The pseudo error identification information is the identification information that is possible to identify the pseudo error. The generation factor is information indicating the factor for generating the pseudo error.

The generation factor is a generation request of the pseudo error from the POS terminal 2 which is notified by operating the keyboard 22 or the touch panel 23, for example. For example, the generation factor is a conveyance factor of enabling money such as bills, coins, and the like to be conveyed. Or, for example, the generation factor is an operation from the first operation section 43 or the second operation section 53. Or, for example, the generation factor is the detection of money by the money sensor 305. Or, the generation factor may be that a given time elapses after a pseudo error serving as a training target is selected. Or, the generation factor may be that a pseudo error serving as a training target is selected. The notification information is notified when a pseudo error is generated. The guide information is used to guide an operation for releasing the error condition when a pseudo error is generated.

The release factor is information indicating a factor for releasing the pseudo error. In a case of the pseudo error, the money depositing and dispensing system 1 does not become the error condition in practice. Thus, in a case in which a predetermined condition is detected, the money depositing and dispensing system 1 releases the pseudo error condition. Specifically, the release factor is, for example, the detection of the opening/closing of the predetermined positions of the casing 41 and/or the casing 51 by the casing opening/closing sensor 309. In this way, the operator executes training of opening/closing a position where it is assumed that a predetermined error is generated for each pseudo error. Further, the release factor is not limited to one, and may be more than one. For example, in a case in which the inside of the casing 41 and that of the casing 51 are respectively divided into multiple divisions, the release factor may be the detection of opening/closing of each of the multiple divisions. Or, the release factor may be a combination of the detection of opening/closing of the casing 41 and the casing 51 with an initializing operation.

The connection interface 303 is connected with the POS terminal 2.

The conveyance section 304 conveys at least either the deposited money or dispensed money. The conveyance section 304 comprises a money depositing port motor 3041, a conveyance motor 3042, and a payment motor 3043.

If a money depositing port sensor 3051 detects bills and/or coins, the money depositing port motor 3041 acquires bills and/or coins. The conveyance motor 3042 drives a conveyance belt (not shown) which conveys money to a storing section storing bills and/or coins. In this way, the conveyance motor 3042 conveys the bills input to the bill depositing port 44 or the coins input to the coin depositing port 54 to the storing section (not shown). The payment motor 3043 drives a payment belt (not shown) that is arranged on the bottom surface of the storing section (not shown). In this way, the payment motor 3043 pays the bills or coins stored in the storing section (not shown) to the bill dispensing port 45 or the coin dispensing port 55.

The money sensor 305 detects money such as bills, coins, and the like. The money sensor 305 consists of the money depositing port sensor 3051, a denomination identification sensor 3052, a money dispensing port residual detection sensor 3053, a storing count sensor 3054, a payment count sensor 3055, and a reject forgetting sensor 3056.

For example, the money depositing port sensor 3051 is a light sensor. Each of the bill depositing port 44 and the coin depositing port 54 is equipped with the money depositing port sensor 3051. The money depositing port sensor 3051 which is arranged in the bill depositing port 44 detects the deposited bills. The money depositing port sensor 3051 which is arranged in the coin depositing port 54 detects the deposited coins.

For example, the denomination identification sensor 3052 is a light receiving sensor. The denomination identification sensor 3052 identifies the denomination of money input to the bill depositing port 44 and the coin depositing port 54.

For example, the money dispensing port residual detection sensor 3053 is a light sensor or a magnetic sensor. Each of the bill dispensing port 45 and the coin dispensing port 55 is equipped with the money dispensing port residual detection sensor 3053. The money dispensing port residual detection sensor 3053 which is arranged in the bill dispensing port 45 detects the bills passing through the bill dispensing port 45. The money dispensing port residual detection sensor 3053 which is arranged in the coin dispensing port 55 detects the coins passing through the coin dispensing port 55.

For example, the storing count sensor 3054 is a light sensor. Then, the storing count sensor 3054 counts the number of the bills and coins conveyed to the storing section (not shown).

For example, the payment count sensor 3055 is an optical sensor. Then, the payment count sensor 3055 counts the number of the bills and coins paid from the storing section (not shown).

For example, the reject forgetting sensor 3056 is a light sensor or a magnetic sensor. The reject forgetting sensor 3056 detects bills or coins on a reject section (not shown).

The buzzer 306 notifies the operator of an error with sound, light, blinking light, and/or vibration.

The reject shutter solenoid 307 is a solenoid used to open/close a shutter for blocking a reject hole through which bills or coins are discharged to the reject section (not shown).

The unit opening/closing solenoid 308 is a solenoid used to drive a lock member which locks in such a manner that a main body (not shown) of each of the bill depositing and dispensing unit 4 and the coin depositing and dispensing unit 5 is not pulled out of the casing 41 and the casing 51 respectively.

For example, the casing opening/closing sensor 309 is an opening/closing detection sensor. The casing opening/closing sensor 309 detects the opening/closing of the casing 41 of the bill depositing and dispensing unit 4 or the opening/closing of the casing 51 of the coin depositing and dispensing unit 5. Further, the casing opening/closing sensors 309 are also respectively arranged in all the divisions such as the main body, the storing section and the like. Then, the casing opening/closing sensors 309 detect the opening/closing of all the divisions.

Next, the characteristic functions of all devices of the money depositing and dispensing system 1 are described. Herein, FIG. 5 is a block diagram illustrating the functional components of all the devices of the money depositing and dispensing system 1.

First, the functional components of the POS terminal 2 are described.

The CPU of the control section 200 copies or decompresses the training program PR1 in the storage section 202 on the RAM to operate according to the training program PR1, and in this way, generates the functional sections shown in FIG. 5 on the RAM. Specially, the control section 200 consists of a connection control section 2001, an operation control section 2002, and a display control section 2003 as the functional sections.

The connection control section 2001 controls the connection interface 204 to control the communication with the money depositing and dispensing apparatus 3. The connection control section 2001 sends a pseudo error notification to the money depositing and dispensing apparatus 3. The pseudo error notification refers to a notification used to request generation of an error which relates to the conveyance section 304 and is experienced by the operator to execute the training. The pseudo error notification further contains pseudo error identification information indicating the generated pseudo error. Alternatively, the connection control section 2001 receives a generation notification and a restoration notification from the money depositing and dispensing apparatus 3, for example. The generation notification refers to that an error relating to the conveyance section 304 is generated, which is notified by the pseudo error notification. The POS terminal 2 receives the generation notification to notify that the error relating to the conveyance section 304 is generated, which is notified by the pseudo error notification. The restoration notification refers to the restoration from the error relating to the conveyance section 304, which is notified by the pseudo error notification. By receiving the restoration notification, the POS terminal 2 terminates the notification of the generation of the error relating to the conveyance section 304, which is notified by the pseudo error notification.

The operation control section 2002 receives various operations from the keyboard 22 or the touch panel 23. For example, the operation control section 2002 receives an input for designating a pseudo error that is to be experienced by the operator. Alternatively, for example, the operation control section 2002 receives an input of the generation factor or the release factor of the pseudo error.

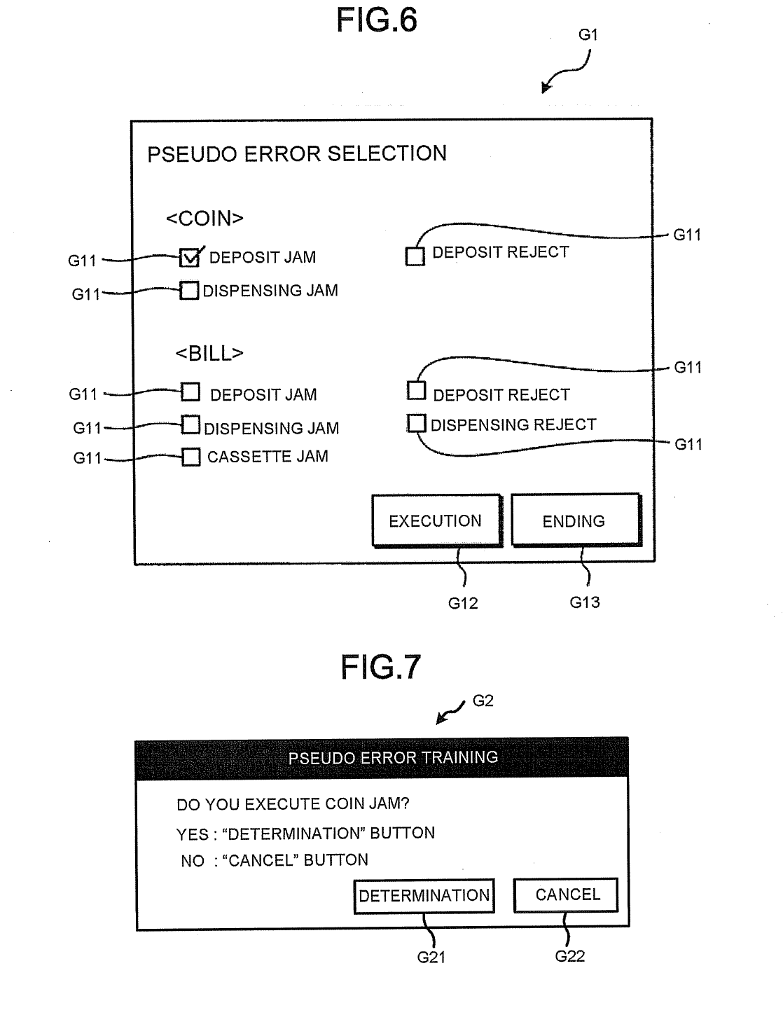

The display control section 2003 displays various screens on the display section 24 for store clerk and the display section 25 for customer. Specifically, the display control section 2003 displays a pseudo error selection screen. Herein, FIG. 6 is an illustration diagram illustrating an example of a pseudo error selection screen G1. The pseudo error selection screen G1 is used to select the pseudo errors for training. The pseudo error selection screen G1 includes a check box G11, an execution button G12 and an ending button G13. The check box G11 is used to select the pseudo errors which are generated in a pseudo manner. The execution button G12 is pressed when a pseudo error selected with the check box G11 is executed. The ending button G13 is pressed when the selection of the pseudo error is ended. Further, the pseudo error selection screen G1 shown in FIG. 6 illustrates a case in which a pseudo error of coin jam is generated.

Further, in a case in which a pseudo error is selected on the pseudo error selection screen G1, the display control section 2003 displays a confirmation screen for confirming whether or not the selected pseudo error is executed. Herein, FIG. 7 is an illustration diagram illustrating an example of a confirmation screen G2. The confirmation screen G2 includes a determination button G21 and a cancel button G22. The determination button G21 is pressed when determining that the selected pseudo error is executed. The cancel button G22 is pressed when canceling the execution of the selected pseudo error. Further, the confirmation screen shown in FIG. 7 is a screen for confirming whether to execute the coin jam.

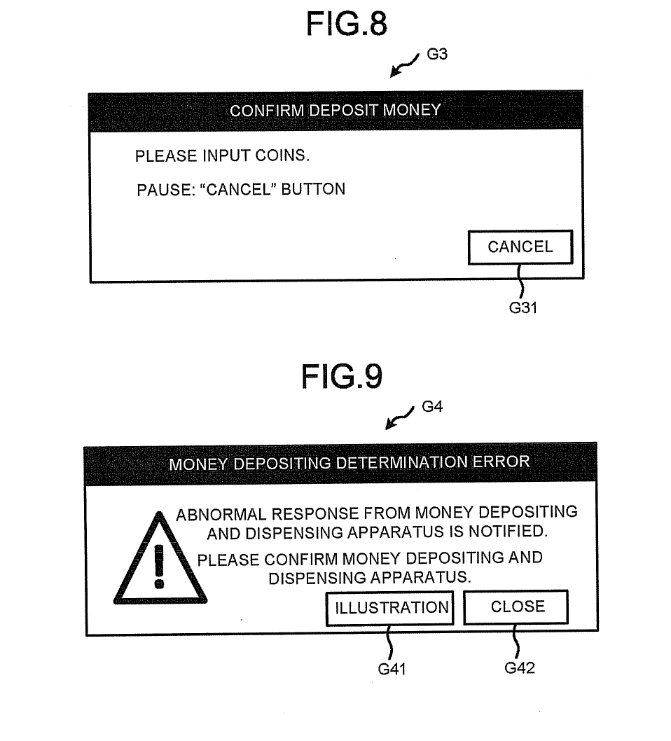

If it is determined to execute the pseudo error selected on the confirmation screen G2, the display control section 2003 displays an operation input screen on which an input of the generation factor of the pseudo error is required. The display control section 2003 reads a generation factor, which is associated with the pseudo error identification information of the pseudo error to be generated, from the pseudo error table T1 through the connection interface 204. The display control section 2003 displays an operation input screen on which the read generation factor is indicated. Herein, FIG. 8 is an illustration diagram illustrating an example of an operation input screen G3. The operation input screen G3 includes a cancel button G31 which is pressed when canceling generation of the pseudo error. Since the operation input screen G3 shown in FIG. 8 is the operation input screen G3 relating to the coin jam, a message “Please input coins” is displayed.

When the generation factor of the pseudo error is detected, the display control section 2003 displays a POS terminal notification screen for notifying that the pseudo error is generated. The display control section 2003 reads notification information which is associated with the pseudo error identification information of a pseudo error to be generated from the pseudo error table T1 through the connection interface 204. The display control section 2003 displays a POS terminal notification screen G4 on which the read notification information is indicated. Herein, FIG. 9 is an illustration diagram illustrating an example of the POS terminal notification screen G4. The POS terminal notification screen G4 is a screen for notifying that the pseudo error is generated. The POS terminal notification screen G4 includes an illustration button G41 and a close button G42. The illustration button G41 is pressed when a method for restoring from the pseudo error is displayed. The close button G42 is pressed when the POS terminal notification screen G4 is closed.

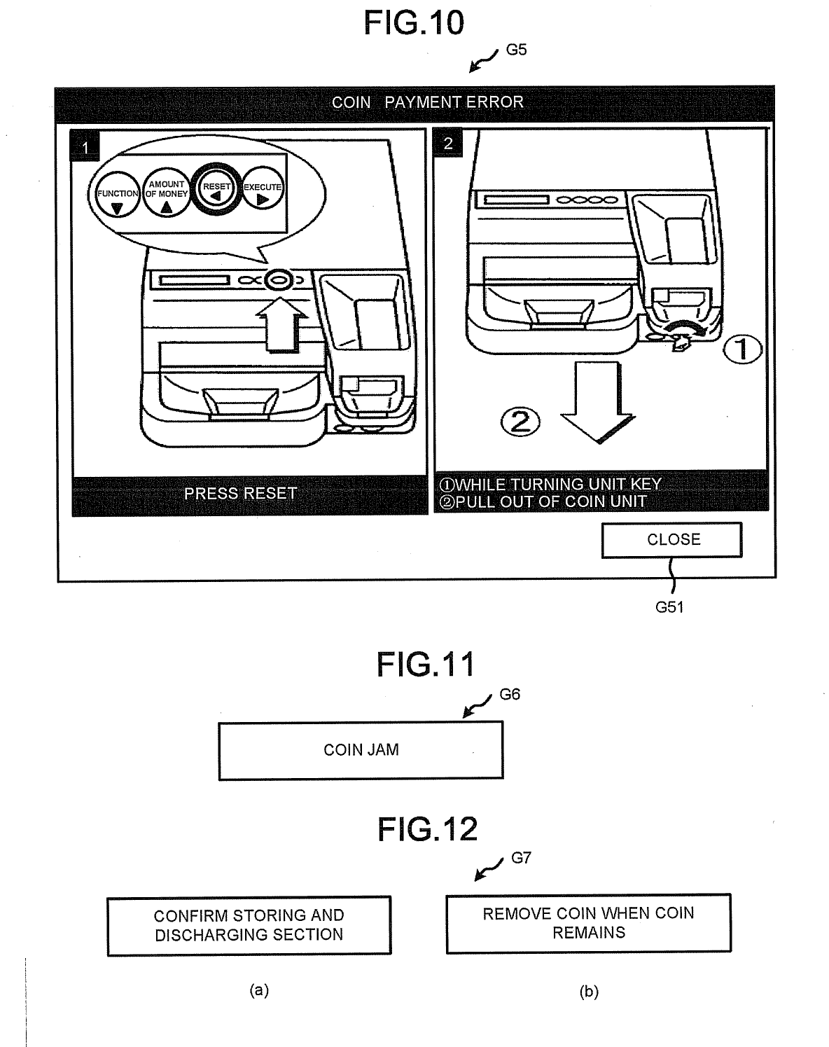

Furthermore, the display control section 2003 (display control module) displays a guide screen on which the method for restoring from the pseudo error is indicated. Herein, FIG. 10 is an illustration diagram illustrating an example of a POS terminal guide screen G5. The POS terminal guide screen G5 comprises a close button G51 which is pressed when closing the POS terminal guide screen G5. As shown in FIG. 10, the POS terminal guide screen G5 presents a restoration method with an image and a message.

Next, the functional components of the money depositing and dispensing apparatus 3 are described.

The CPU of the control section 300 copies or decompresses the training program PR2 in the storage section 302 on the RAM to operate according to the training program PR2, and in this way, generates the functional sections shown in FIG. 5 on the RAM. Specially, the control section 300 consists of a connection control section 3001, an operation control section 3002, a pseudo error control section 3003, a conveyance control section 3004, and a display control section 3005 as the functional sections.

The connection control section 3001 controls the connection interface 303 to control the communication with the POS terminal 2. The connection control section 3001 (reception module) receives the reception of a pseudo error notification from the POS terminal 2, for example. Alternatively, the connection control section 3001 sends a generation notification and a restoration notification to the POS terminal 2, for example.

The operation control section 3002 receives various operations from the first operation section 43 or the second operation section 53. Then, the operation control section 3002 receives an input of a generation factor or a release factor of the pseudo factor, for example. Alternatively, the operation control section 3002 receives an operation for enabling the conveyance section 304 to convey money as the generation factor of the pseudo error.

The pseudo error control section 3003 controls a pseudo error processing. Herein, the pseudo error refers to an artificial error which is to be experienced by the operator and is not generated in practice. Thus, the pseudo error processing is a processing of notifying that an error selected on the pseudo error selection screen G1 is generated after prohibiting conveyance of money. More specifically, the pseudo error processing refers to a processing of prohibiting the driving of the conveyance section 304 and enabling the notification information or guide information associated with the pseudo error identification information to be displayed on the display control section 2003 or on the display control section 3005.

In a case of receiving the pseudo error notification, the pseudo error control section 3003 detects a generation factor of a pseudo error associated with the pseudo error identification information contained in the pseudo error notification in the pseudo error table T1. In other words, the pseudo error control section 3003 detects a generation factor, received by the operation control section 2002, which results in the generation of the pseudo error on the pseudo error selection screen G1. Specifically, the pseudo error control section 3003 (detection module) detects a conveyance factor which results in enabling the conveyance section 304 to convey money as a generation factor. For example, through factors such as operating the keyboard 22 or the touch panel 23, the pseudo error control section 3003 detects a notification requesting the conveyance of money sent from the POS terminal 2 as a conveyance factor. Alternatively, for example, the pseudo error control section 3003 detects an operation that is received by the first operation section 43 or the second operation section 53 as a conveyance factor. Alternatively, for example, the pseudo error control section 3003 detects the detection of money by the money sensor 305 as a conveyance factor.

Alternatively, the pseudo error control section 3003 detects a generation request of a pseudo error from the POS terminal 2 which is notified by operating the keyboard 22 or the touch panel 23. Alternatively, for example, the pseudo error control section 3003 detects an operation received by the first operation section 43 or the second operation section 53 as a generation factor. Alternatively, for example, the pseudo error control section 3003 detects the detection of money by the money sensor 305 as a generation factor. Alternatively, for example, the pseudo error control section 3003 detects that a given time elapses after a pseudo error serving as a training target is selected as a generation factor. Alternatively, for example, the pseudo error control section 3003 may detect that a pseudo error serving as a training target is selected as a generation factor.

Then, if a generation factor of the pseudo error is detected, the pseudo error control section 3003 executes a pseudo error processing. The pseudo error control section 3003 then detects a release factor of the pseudo error associated with the pseudo error identification information contained in the pseudo error notification in the pseudo error table T1. Specifically, the pseudo error control section 3003 detects that the opening/closing of the predetermined positions of the casing 41 of the bill depositing and dispensing unit 4 or the casing 51 of the coin depositing and dispensing unit 5 is detected by the casing opening/closing sensor 309 as a release factor of the pseudo error. Alternatively, the pseudo error control section 3003 detects an ending request of the pseudo error from the POS terminal 2 which is notified by operating the keyboard 22 or the touch panel 23 as a release factor. Alternatively, for example, the pseudo error control section 3003 detects an operation received by the first operation section 43 or the second operation section 53 as a release factor. Alternatively, for example, the pseudo error control section 3003 detects the detection of the opening/closing of the casing 41 or the casing 51 and the initializing operation as release factors. Further, the pseudo error control section 3003 terminates the pseudo error processing when detecting one or more release factors.

The conveyance control section 3004 controls the conveyance section 304. Specifically, in a case of detecting the conveyance factor of bills or coins, the conveyance control section 3004 enables the conveyance section 304 to convey money. Then, the conveyance control section 3004 conveys the bills and coins which are stored in the storing section to the bill dispensing port 45 or the coin dispensing port 55 respectively in the money dispensing processing. Alternatively, the conveyance control section 3004 conveys the bills that are put into the bill depositing port 44 or the coins that are put into the coin depositing port 54 to the storing section respectively in the money depositing processing. Further, even if a conveyance factor of bills or coins is detected when the connection control section 3001 receives a pseudo error notification, the conveyance control section 3004 (conveyance control module) prohibits the driving of the conveyance section 304. That is, the conveyance control section 3004 prohibits the conveyance of bills or coins by the conveyance section 304.

The display control section 3005 enables the first display section 42 and the second display section 52 to display various screens. Specifically, in a case in which the pseudo error control section 3003 detects a generation factor of the pseudo error, the display control section 3005 (notification module) displays a money depositing and dispensing apparatus notification screen for notifying that an error relating to a pseudo error notification received by the connection control section 3001 is generated. Herein, FIG. 11 is an illustration diagram illustrating an example of a money depositing and dispensing apparatus notification screen G6. The money depositing and dispensing apparatus notification screen G6 shown in FIG. 11 displays a message “coin jam” to indicate that a pseudo error relating to the coin jam is generated.

Alternatively, the display control section 3005 displays a guide screen on which a method for restoring from the pseudo error is indicated. Herein, FIG. 12 is an illustration diagram illustrating an example of a money depositing and dispensing apparatus guide screen G7. The display control section 3005 displays a money depositing and dispensing apparatus guide screen G7 in FIG. 12 (a) and a money depositing and dispensing apparatus guide screen G7 in FIG. 12 (b) alternatively at each given time. The money depositing and dispensing apparatus guide screen G7 shown in FIG. 12(a) displays a message “Confirm storing and discharging section”. Then, the money depositing and dispensing apparatus guide screen G7 shown in FIG. 12(b) displays a message “Remove coins when coins remain”. In this way, the money depositing and dispensing apparatus guide screen G7 shown in FIG. 12 illustrates the confirmation of the storing section storing coins and a discharging section discharging the coins from the storing section because of the occurrence of the coin jam and the removing of coins when the coin jam occurs.

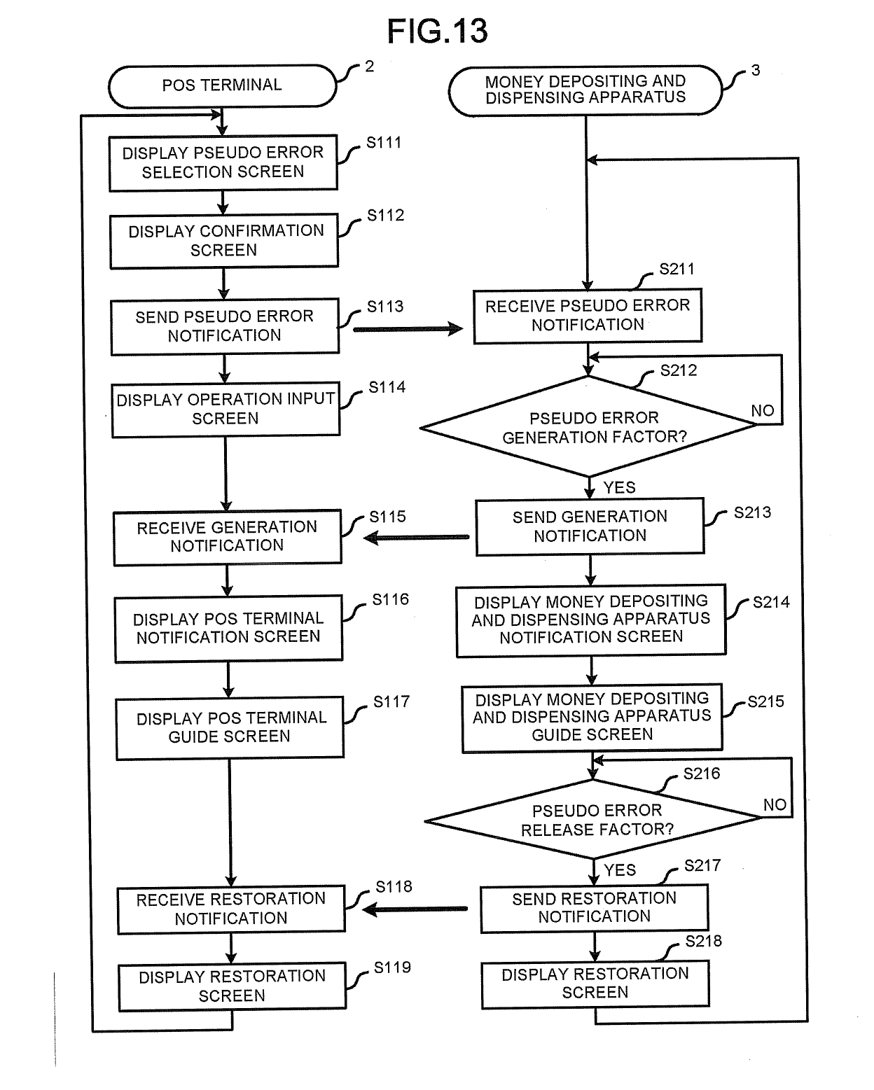

Next, a pseudo error processing executed by the money depositing and dispensing system 1 is described. Herein, FIG. 13 is a flowchart illustrating an example of the pseudo error processing executed by the money depositing and dispensing system 1.

First, the display control section 2003 of the POS terminal 2 displays the pseudo error selection screen G1 (ACT S111). In this way, the display control section 2003 of the POS terminal 2 receives the selection of the pseudo errors to be generated.

Next, the display control section 2003 of the POS terminal 2 displays the confirmation screen G2 (ACT S112). In this way, the display control section 2003 of the POS terminal 2 confirms that a pseudo error is generated.

Sequentially, the connection control section 2001 of the POS terminal 2 sends a selected pseudo error notification to the money depositing and dispensing apparatus 3 (ACT S113). Next, the display control section 2003 of the POS terminal 2 displays the operation input screen G3 (ACT S114).

On the other hand, the connection control section 3001 of the money depositing and dispensing apparatus 3 receives the pseudo error notification (ACT S211).

Next, the pseudo error control section 3003 of the money depositing and dispensing apparatus 3 determines whether to detect a generation factor for generating the pseudo error (ACT S212). In a case of not detecting a generation factor (NO in ACT S212), the pseudo error control section 3003 of the money depositing and dispensing apparatus 3 waits for until a generation factor is detected.

On the other hand, in a case in which a generation factor is detected (YES in ACT S212), the connection control section 3001 of the money depositing and dispensing apparatus 3 sends a generation notification to the POS terminal 2 (ACT S213). Accordingly, the connection control section 2001 of the POS terminal 2 receives a generation notification (ACT S115).

Next, the display control section 2003 of the POS terminal 2 displays the POS terminal notification screen G4 (ACT S116). The display control section 3005 of the money depositing and dispensing apparatus 3 further displays the money depositing and dispensing apparatus notification screen G6 (ACT S214).

Next, the display control section 2003 of the POS terminal 2 displays the POS terminal guide screen G5 (ACT S117). Further, the display control section 3005 of the money depositing and dispensing apparatus 3 displays the money depositing and dispensing apparatus guide screen G7 (ACT S215).

Next, the pseudo error control section 3003 of the money depositing and dispensing apparatus 3 determines whether to detect a release factor for releasing the pseudo error (ACT S216). In a case of not detecting a release factor (NO in ACT S216), the pseudo error control section 3003 of the money depositing and dispensing apparatus 3 waits for until a release factor is detected.

On the other hand, in a case in which a release factor is detected (YES in ACT S216), the connection control section 3001 of the money depositing and dispensing apparatus 3 sends a restoration notification to the POS terminal 2 (ACT S217) Accordingly, the connection control section 2001 of the POS terminal 2 receives the restoration notification (ACT S118).

Next, after a restoration screen (not shown) indicating the restoration from the pseudo error is displayed (ACT S119), the display control section 2003 of the POS terminal 2 returns to the processing in ACT S111 to display the pseudo error selection screen G1. After the restoration screen (not shown) indicating that the restoration from the pseudo error is displayed (ACT S218), the pseudo error control section 3003 of the money depositing and dispensing apparatus 3 returns to the processing in ACT S211.

In this way, the money depositing and dispensing system 1 terminates the pseudo error processing.

As described above, according to the money depositing and dispensing apparatus 3 of the present embodiment, the connection control section 3001 receives a pseudo error notification requesting the generation of an error which relates to the conveyance section 304 and is to be experienced by the operator. In a case of receiving the pseudo error notification, the conveyance control section 3004 prohibits the conveyance of money by the conveyance section 304. On the other hand, the display control section 3005 displays the money depositing and dispensing apparatus notification screen G6 and the money depositing and dispensing apparatus guide screen G7. Thus, in the training of the releasing method of the error conditions for the operator, the jammed money is not put into the money depositing and dispensing apparatus by mistake and an undesirable miscalculation condition due to the money jam does not occur, and in this way, the amount of money in the money depositing and dispensing apparatus does not become inaccurate. Thus, as to the money depositing and dispensing apparatus 3 which is possible to relieve the prior preparations of the operator, it is easy to train the releasing method of the error condition.

As another embodiment, the above-described embodiment may be applied to a single apparatus comprising the functional components of the POS terminal 2 and the money depositing and dispensing apparatus 3. For example, the above-described embodiment can be applied to a self-checkout apparatus (hereinafter, referred to as self-POS terminal simply) through which the customer executes a commodity registration processing or a checkout processing by himself or herself. The customer uses the self-POS terminal by himself or herself; however, it is necessary to train the operator in advance to restore the self-POS terminal when an error such as a coin jam occurs.

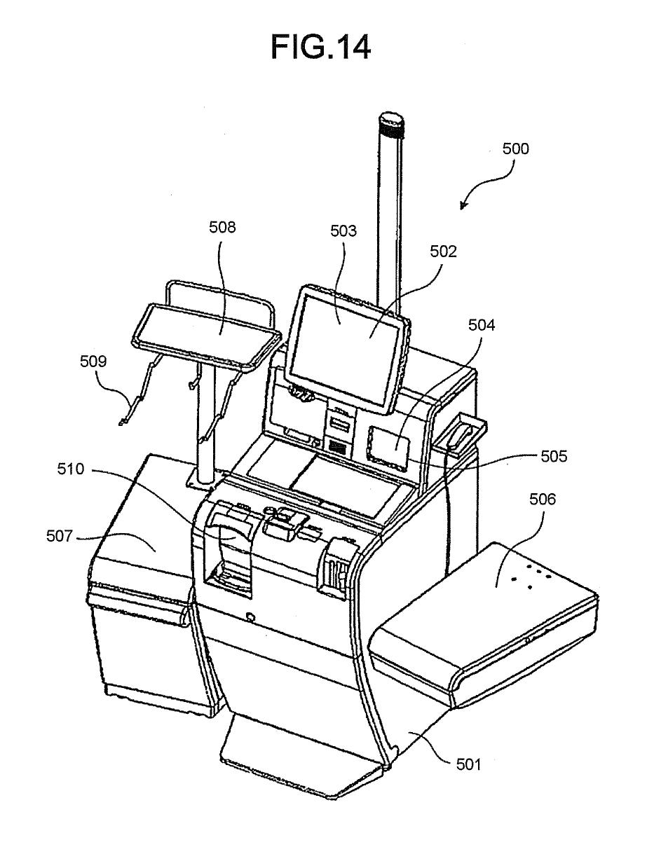

FIG. 14 is an external perspective view illustrating the schematic constitution of a self-POS terminal 500 serving as another embodiment. As shown in FIG. 14, a main body 501 of the self-POS terminal 500 comprises a display device 503 on the surface of which a touch panel 502 is arranged, and a commodity reading section 504 reading commodity images to recognize (detect) the category and the like of a commodity.

For example, a liquid crystal display is used as the display device 503. The display device 503 displays a guidance screen for notifying the customer of the operation method of the self-POS terminal 500, various input screens, a registration screen for displaying commodity information read by a commodity reading section 504, a settlement screen on which total amount and deposit amount of commodities are displayed and a payment method is selected, etc.

The customer holds a code symbol attached to a commodity to a reading window 505 of the commodity reading section 504, and in this way, the commodity reading section 504 reads a commodity image with an image capturing section arranged inside the reading window 505.

A commodity placing table 506 for placing unsettled commodities which are put into a basket is arranged at the right side of the main body 501. A commodity placing table 507 for placing settled commodities is arranged at the left side of the main body 501. A temporary placing table 508 is arranged on the upper part of the rear side of the commodity placing table 507 in a protruding manner to temporarily place the settled commodities before the settled commodities are put into a bag. A pair of bag hooks 509 is arranged at the near side end part of the temporarily placing table 508 to hook bags used for putting the settled commodities therein. Each of the commodity placing table 506 and the commodity placing table 507 is equipped with a weighing scale, and the weighing scale has a function of confirming whether or not the weight of the commodities is the same before and after the settlement.

A money depositing and dispensing apparatus 510 is arranged in the main body 501 of the self-POS terminal 500 to deposit bills for settlement and dispense bills as change.

In the self-POS terminal 500 with the above constitution, the functional components of the above-described POS terminal 2 (refer to FIG. 1, FIG. 2 and FIG. 5) may be applied to the self-POS terminal 500. Further, the functional components of the above-described money depositing and dispensing apparatus 3 (refer to FIG. 1, FIG. 3 and FIG. 5) may be applied to the money depositing and dispensing apparatus 510.

While certain embodiments are described, these embodiments are presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

Further, in the embodiment described above, it is described that the POS terminal 2 and the money depositing and dispensing apparatus 3 carry out a notification indicating that a pseudo error is generated and a guide of a restoration method restoring from the pseudo error through displaying them on the display section 24 for store clerk, the display section 25 for customer, the first display section 42 and the second display section 52. However, as to the notification and the guide method, it is not limited to be displayed, and it may be given with sound. In this case, the POS terminal 2 and the money depositing and dispensing apparatus 3 may be provided with a speaker respectively, and the notification content and the guide content may be issued through the speakers thereof. Further, the notification and the guide method may be given through the combination of the display with the sound.

The programs executed by each apparatus described in the embodiment or modifications above are pre-incorporated in the storage medium (ROM or storage section) of each apparatus; however, the present invention is not limited to this. For example, the programs may be recorded in a computer-readable recording medium such as CD-ROM, FD (Flexible Disk), CD-R, DVD (Digital Versatile Disk) in the form of installable or executable file to be provided. Further, the storage medium, which is not limited to a medium independent from a computer or an incorporated system, further includes a storage medium for storing or temporarily storing the downloaded program transferred via a LAN or an Internet.

In addition, the programs executed by each apparatus described in the embodiment or modifications above may be stored on a computer connected with a network such as the Internet or downloaded via the network to be provided, or provided or distributed via the network such as the Internet.

What is claimed is:

1. A money depositing and dispensing apparatus, comprising:
a conveyance section configured to convey at least either deposited money or dispensed money;
a reception module configured to receive a generation notification used to generate an error which relates to the conveyance section and is to be experienced by an operator;
a conveyance control module configured to prohibit the conveyance of money by the conveyance section in a case in which the reception module receives the generation notification; and
a notification module configured to notify the operator that the error, received by the reception module, which relates to the conveyance section is generated.

2. The money depositing and dispensing apparatus according to claim 1, further comprising:
a detection module configured to detect a conveyance factor of enabling the conveyance section to convey money, wherein
the conveyance control module prohibits, when the reception module receives the generation notification, the conveyance of money by the conveyance section even in a case in which the detection module detects the conveyance factor; and
the notification module notifies that the error, received by the reception module, which relates to the conveyance section is generated in a case in which the detection module detects the conveyance factor.

3. The money depositing and dispensing apparatus according to claim 2, further comprising:
an operation section configured to receive various operations, wherein
the detection module detects an operation received by the operation section as the conveyance factor.

4. The money depositing and dispensing apparatus according to claim 2, further comprising:
a sensor configured to detect money, wherein
the detection module detects the money detection by the sensor as the conveyance factor.

5. A money depositing and dispensing system, comprising:
a conveyance section configured to convey at least either the deposited money or dispensed money;
a reception module configured to receive a generation notification used to generate an error which relates to the conveyance section and is to be experienced by an operator;
a conveyance control module configured to prohibit the conveyance of money by the conveyance section in a case in which the reception module receives the generation notification;
a notification module configured to notify the operator that the error, received by the reception module, which relates to the conveyance section is generated; and
a display control module configured to display a method for restoring from a pseudo error notified by the notification module on a display section.

6. A method for training a releasing method of an error condition by a money depositing and dispensing apparatus which comprises a conveyance section configured to convey at least either deposited money or dispensed money, comprising:
receiving a generation notification used to generate an error which relates to the conveyance section and is to be experienced by an operator;
prohibiting the conveyance of money by the conveyance section in a case of receiving the generation notification; and
notifying the operator that the received error which relates to the conveyance section is generated.
